(19) United States
(12) Patent Application Publication
(10) Pub. No.: US 2025/0116514 A1
(43) Pub. Date: Apr. 10, 2025

(54) DISTANCE IMAGE CAPTURING DEVICE AND DISTANCE IMAGE CAPTURING METHOD

(71) Applicant: TOPPAN Holdings Inc., Tokyo (JP)

(72) Inventors: Masanori NAGASE, Tokyo (JP); Kunihiro HATAKEYAMA, Tokyo (JP); Keigo ISOBE, Tokyo (JP)

(73) Assignee: TOPPAN Holdings Inc., Tokyo (JP)

(21) Appl. No.: 18/908,830

(22) Filed: Oct. 8, 2024

(30) Foreign Application Priority Data
Oct. 10, 2023 (JP) 2023-175205

(51) Int. Cl. G01C 3/06; H04N 23/56

(52) U.S. Cl. CPC G01C 3/06; H04N 23/56

(57) ABSTRACT

A light source unit, a light receiving unit including a distance image sensor in which a plurality of pixels are arranged and a pixel driving circuit, and a distance calculation unit calculating a distance to a subject based on electric charge amount accumulated in each of the charge accumulation units are provided, and a relationship between the emission timing and the accumulation timing is set such that electric charges corresponding to reflected light of the optical pulse reflected from the subject is accumulated in any of the three or more charge accumulation units provided in the pixels, and the distance calculation unit calculates the distance to the subject by using the same calculation equation regardless of which two charge accumulation units, in which electric charges are successively accumulated, among the three or more charge accumulation units provided in the pixels accumulate the electric charges corresponding to the reflected light.

### CROSS-REFERENCE TO RELATED APPLICATION

This application claims priority from Japanese Patent Application No. 2023-175205, filed on Oct. 10, 2023, the content of which is incorporated herein by reference.

### BACKGROUND OF THE INVENTION

### Field of the Invention

The disclosure relates to a distance image capturing device and a distance image capturing method.

### Description of Related Art

A time of flight (hereinafter, referred to as “ToF”) type distance image capturing device is implemented that uses a known speed of light and measures a distance between a measurement instrument and a target object based on a flight time of light in a space (measurement space) (for example, refer to Japanese Patent No. 4235729).

Such a distance image capturing device is also referred to as a multi-tap ToF sensor or the like because a plurality of charge accumulation units are provided in an imaging element. By emitting pulsed light to a subject and causing reflected light reflected by a measurement target object to be incident on the imaging element, electric charges corresponding to the reflected light are accumulated in two charge accumulation units, and a distance to the subject is calculated based on an electric charge ratio of the electric charges accumulated in the two charge accumulation units.

When three or more charge accumulation units are provided in a pixel (imaging element), measurement using a plurality of time windows (TWs) can be performed. For example, when three charge accumulation units of a first charge accumulation unit to a third charge accumulation unit are provided in the pixel, measurement can be performed by using two TWs (a first TW and a second TW). The first TW corresponds to a case where the electric charges corresponding to the reflected light are accumulated in the first charge accumulation unit and a second charge accumulation unit. The second TW corresponds to a case where the electric charges corresponding to the reflected light are accumulated in the second charge accumulation unit and the third charge accumulation unit. By performing measurement by using a plurality of TWs, it is possible to extend a measurable distance as compared with a case where measurement is performed by using one TW, and it is possible to increase a measurement accuracy when the measurable distance is the same.

### SUMMARY OF THE INVENTION

However, in a process of calculating a distance to a subject, a multi-tap ToF sensor of the related art using a plurality of TWs requires processing according to whether electric charges corresponding to the reflected light are accumulated in a charge accumulation unit corresponding to any TW. For example, it is necessary to select two pixel signals having large output values in order to specify the charge accumulation unit in which the electric charges corresponding to the reflected light are accumulated. Alternatively, it is necessary to select one or more pixel signals having a small output value in order to specify an output value corresponding to ambient light. There is a problem in that such processing of determination or case division has to be performed and processing is complicated.

The disclosure is made based on the above-described problems, and an object of the disclosure is to provide a distance image capturing device and a distance image capturing method capable of easily performing processing of calculating a distance to a subject in a case of performing measurement using a plurality of TWs.

A distance image capturing device of the disclosure includes a light source unit configured to emit an optical pulse to a subject, a light receiving unit including a distance image sensor in which a plurality of pixels, each having a photoelectric conversion element that generates electric charges according to incident light and three or more charge accumulation units that accumulate electric charges, are arranged in a two-dimensional matrix form, and a pixel driving circuit configured to distribute electric charges to each of the charge accumulation units at an accumulation timing synchronized with an emission timing for emitting the optical pulse and accumulate the electric charges in each of the charge accumulation units, and a distance calculation unit configured to calculate a distance to the subject based on an electric charge amount accumulated in each of the charge accumulation units, in which a relationship between the emission timing and the accumulation timing is set such that electric charges corresponding to reflected light of the optical pulse reflected from the subject are accumulated in any two charge accumulation units, in which electric charges are successively accumulated, among the three or more charge accumulation units provided in the pixel, and the distance calculation unit calculates the distance to the subject by using the same calculation equation regardless of which of the three or more charge accumulation units provided in the pixels accumulates the electric charges corresponding to the reflected light.

A distance image capturing method of the disclosure is a distance image capturing method performed by a distance image capturing device including a light source unit configured to emit an optical pulse to a subject, a light receiving unit including a distance image sensor in which a plurality of pixels, each having a photoelectric conversion element that generates electric charges according to incident light and three or more charge accumulation units that accumulate electric charges, are arranged in a two-dimensional matrix form, and a pixel driving circuit which distributes electric charges to each of the charge accumulation units at an accumulation timing synchronized with an emission timing for emitting the optical pulse and accumulates the electric charges in each of the charge accumulation units, and a distance calculation unit configured to calculate a distance to the subject based on an electric charge amount accumulated in each of the charge accumulation units, and includes setting a relationship between the emission timing and the accumulation timing such that electric charges corresponding to reflected light of the optical pulse reflected from the subject are accumulated in any two charge accumulation units, in which electric charges are successively accumulated, among the three or more charge accumulation units provided in the pixels, and calculating, via the distance calculation unit, the distance to the subject by using the same calculation equation regardless of which of the three or more charge accumulation units provided in the pixels accumulates the electric charges corresponding to the reflected light.

According to the disclosure, when measurement is performed by using a plurality of TWs, it is possible to easily perform processing of calculating a distance to a subject.

### BRIEF DESCRIPTION OF THE DRAWINGS

FIG. 1 is a block diagram showing a schematic configuration of a distance image capturing device 1 according to an embodiment.

FIG. 2 is a block diagram showing a schematic configuration of a distance image sensor 32 according to an embodiment.

FIG. 3 is a circuit diagram showing an example of a configuration of a pixel 321 according to an embodiment.

FIG. 4 is a timing chart showing an example in which a pixel 321 having a three-tap configuration in the related art is driven to perform measurement by using one TW.

FIG. 5 is a timing chart showing an example in which a pixel 321 having a three-tap configuration in the related art is driven to perform measurement by using one TW.

FIG. 6 is a timing chart showing an example in which a pixel 321 having a four-tap configuration in an embodiment is driven to perform measurement by using two TWs.

FIG. 7 is a timing chart showing an example in which a pixel 321 having a four-tap configuration in an embodiment is driven to perform measurement by using two TWs.

FIG. 8 is a timing chart showing an example in which a pixel 321 having a five-tap configuration in an embodiment is driven to perform measurement by using three TWs.

FIG. 9 is a timing chart showing an example in which a pixel 321 having a six-tap configuration in an embodiment is driven to perform measurement by using four TWs.

FIG. 10 is a timing chart showing an example in which a pixel 321 having a three-tap configuration in an embodiment is driven by using a sub-frame.

### DETAILED DESCRIPTION OF THE INVENTION

Hereinafter, a distance image capturing device of an embodiment will be described with reference to the drawings.

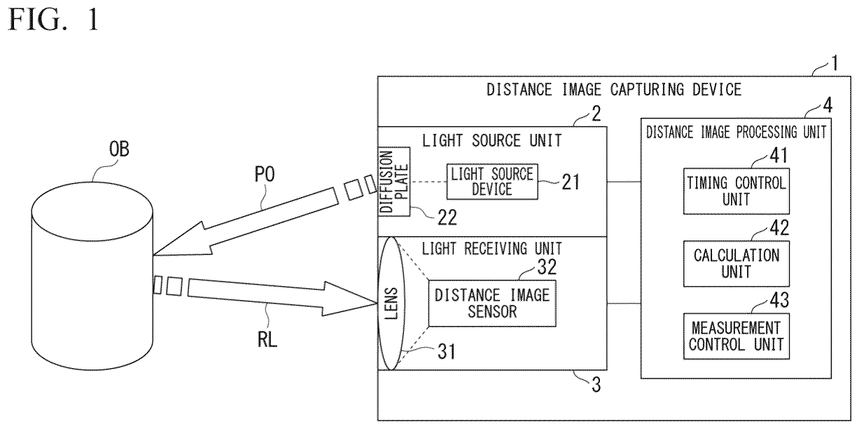

FIG. 1 is a block diagram showing a schematic configuration of a distance image capturing device according to an embodiment. A distance image capturing device 1 includes, for example, a light source unit 2, a light receiving unit 3, and a distance image processing unit 4. FIG. 1 also shows a subject OB that is a target object to which the distance image capturing device 1 measures a distance.

The light source unit 2 emits an optical pulse PO to the subject OB under the control of the distance image processing unit 4. The light source unit 2 is, for example, a surface-emitting type semiconductor laser module such as a vertical cavity surface-emitting laser (VCSEL). The light source unit 2 includes a light source device 21 and a diffusion plate 22.

The light source device 21 is a light source that emits laser light of a near-infrared wavelength band (for example, a wavelength band of a wavelength of 850 nm to 940 nm) which becomes the optical pulse PO to be emitted to the subject OB. The light source device 21 is, for example, a semiconductor laser light emitting element. The light source device 21 emits pulsed laser light under the control of a timing control unit 41.

The diffusion plate 22 is an optical component that diffuses the laser light of the near-infrared wavelength band emitted by the light source device 21 to a size of a surface for emitting the laser light to the subject OB. The pulsed laser light diffused by the diffusion plate 22 is emitted as the optical pulse PO, and emitted to the subject OB.

The light receiving unit 3 receives reflected light RL of the optical pulse PO reflected by the subject OB and outputs a pixel signal corresponding to the received reflected light RL. The light receiving unit 3 includes a lens 31 and a distance image sensor 32.

The lens 31 is an optical lens that guides the incident reflected light RL to the distance image sensor 32. The lens 31 emits the incident reflected light RL to the distance image sensor 32 side, and causes the reflected light RL to be received by (incident on) pixels provided in the light receiving region of the distance image sensor 32.

The distance image sensor 32 is an imaging element. The distance image sensor 32 includes a plurality of pixels arranged in a two-dimensional matrix form. Each of the pixels of the distance image sensor 32 includes one photoelectric conversion element, a plurality of charge accumulation units corresponding to the one photoelectric conversion element, and a component that distributes electric charges to each of the charge accumulation units. That is, the pixel is an imaging element having a distribution configuration by which electric charges are distributed and accumulated in the plurality of charge accumulation units.

The distance image sensor 32 distributes electric charges generated by the photoelectric conversion element to each of the charge accumulation units, under the control of the timing control unit 41. In addition, the distance image sensor 32 outputs a pixel signal corresponding to an electric charge amount distributed to the charge accumulation units. A plurality of pixels are arranged in a two-dimensional matrix form in the distance image sensor 32 which outputs a pixel signal of one frame corresponding to each of pixels.

The distance image processing unit 4 controls the distance image capturing device 1 and calculates a distance to the subject OB. The distance image processing unit 4 includes the timing control unit 41, a distance calculation unit 42, and a measurement control unit 43.

The timing control unit 41 controls timing of outputting various control signals required for measurement under the control of the measurement control unit 43. Here, the various control signals include, for example, a signal that controls emission of the optical pulse PO, a signal that distributes the reflected light RL to the plurality of charge accumulation units to be accumulated therein, a signal that controls the number of times of integration per frame, and the like. The number of times of integration is the number of times of processing of repeating distributing electric charges in the charge accumulation unit in a processing unit (for example, one frame or a sub-frame) and accumulating the electric charges.

The distance calculation unit 42 calculates a distance to the subject OB based on a pixel signal output from the distance image sensor 32, and outputs the calculated distance. The distance calculation unit 42 calculates a delay time from emission of the optical pulse PO to reception of the reflected light RL, based on the electric charge amounts accumulated in the plurality of charge accumulation units, and calculates a distance to the subject OB according to the calculated delay time.

The measurement control unit 43 controls the timing control unit 41. For example, the measurement control unit 43 sets the number of times of integration per processing unit and the like, and controls the timing control unit 41 such that imaging is performed according to the set content.

With such a configuration, in the distance image capturing device 1, the light receiving unit 3 receives the reflected light RL which is obtained as the optical pulse PO of the near-infrared wavelength band emitted to the subject OB is reflected by the light source unit 2 is reflected by the subject OB, and the distance image processing unit 4 outputs distance information obtained by measuring a distance to the subject OB.

Although FIG. 1 shows the distance image capturing device 1 having a configuration in which the distance image processing unit 4 is provided in the distance image capturing device 1, the distance image processing unit 4 may be a component provided outside the distance image capturing device 1.

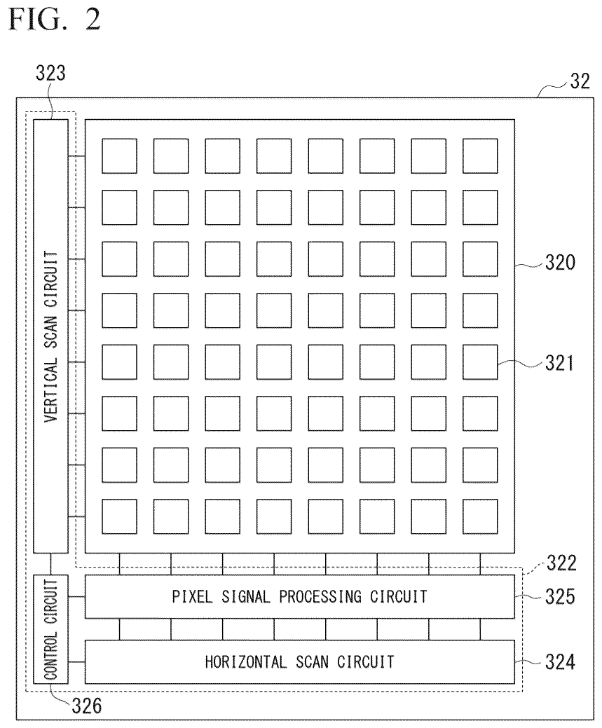

Here, a configuration of the distance image sensor 32 will be described with reference to FIG. 2. FIG. 2 is a block diagram showing a schematic configuration of an imaging element (the distance image sensor 32) used in the distance image capturing device 1 according to the embodiment.

As shown in FIG. 2, the distance image sensor 32 includes, for example, a light receiving region 320 in which a plurality of pixels 321 are arranged in a two-dimensional matrix form, and a pixel driving circuit 322. The pixel driving circuit 322 includes, for example, a vertical scan circuit 323 having a distribution operation, a horizontal scan circuit 324, a pixel signal processing circuit 325, and a control circuit 326.

The light receiving region 320 is a region in which the plurality of pixels 321 are arranged in a two-dimensional matrix form, and FIG. 2 shows an example in which the plurality of pixels 321 are arranged in a two-dimensional matrix form of eight rows and eight columns. The pixel 321 accumulates electric charges corresponding to the received amount of light and outputs an accumulation signal corresponding to the accumulated electric charge amount.

The control circuit 326 collectively controls the distance image sensor 32. For example, the control circuit 326 controls operations of components of the distance image sensor 32 in response to an instruction from the timing control unit 41 of the distance image processing unit 4. The components provided in the distance image sensor 32 may be controlled directly by the timing control unit 41, and in this case, the control circuit 326 can also be omitted.

The vertical scan circuit 323 controls the pixels 321 arranged in the light receiving region 320 for each row under the control of the control circuit 326. The vertical scan circuit 323 outputs a voltage signal according to the electric charge amount accumulated in each of charge accumulation units CS of the pixel 321 to the pixel signal processing circuit 325. For example, the vertical scan circuit 323 distributes the electric charges converted by a photoelectric conversion element to each of the charge accumulation units of the pixels 321 at an accumulation timing synchronized with emission the optical pulse PO and accumulates therein. In addition, the vertical scan circuit 323 discharges the electric charges converted by the photoelectric conversion element from a charge discharging unit (a charge discharging transistor GD to be described below) in a period (for example, a reading period) different from an accumulation period in which the electric charges are accumulated in the charge accumulation unit CS.

The pixel signal processing circuit 325 performs predetermined signal processing (for example, noise suppression processing, A/D conversion processing, or the like) for a voltage signal output to a corresponding vertical signal line from the pixels 321 in each of columns under the control of the control circuit 326.

The horizontal scan circuit 324 sequentially outputs signals output from the pixel signal processing circuit 325 in time series under the control of the control circuit 326. Thereby, an accumulation signal in one frame is sequentially output to the distance image processing unit 4. Hereinafter, it is assumed that the pixel signal processing circuit 325 performs A/D conversion processing and the accumulation signal is a digital signal.

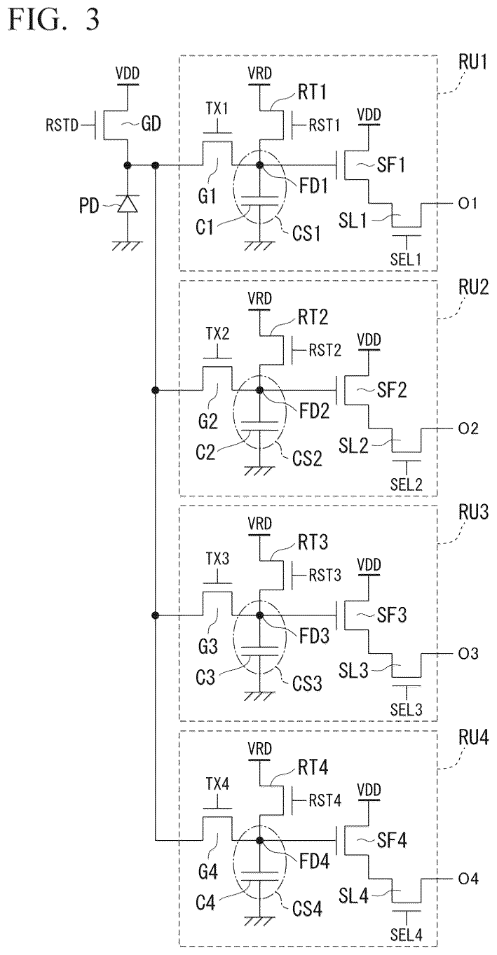

Here, a configuration of the pixel 321 will be described with reference to FIG. 3. FIG. 3 is a circuit diagram showing an example of the pixel 321. FIG. 3 shows an example of the configuration of one pixel 321 among the plurality of pixels 321 arranged in the light receiving region 320. In FIG. 3, an example in which the pixel 321 includes four signal readout units RU (signal readout units RU1 to RU4) is shown.

The pixel 321 includes one photoelectric conversion element PD, a charge discharging transistor GD, and four signal readout units RU that output a voltage signal from a corresponding output terminal O. Each of the signal readout units RU includes a transfer transistor G, a floating diffusion FD, a charge accumulation capacitor C, a reset transistor RT, a source follower transistor SF, and a select transistor SL. The charge accumulation unit CS is configured by the floating diffusion FD and the charge accumulation capacitor C.

In FIG. 3, respective signal readout units RU are distinguished by assigning any one number of “1” to “4” after the reference numeral “RU” of the four signal readout units RU. In addition, likewise, each of the components included in the four signal readout units RU is also represented by distinguishing the signal readout units RU corresponding to the respective component by indicating the number representing each signal readout unit RU after the reference numeral.

In the pixel 321, the signal readout unit RU1 outputs a voltage signal from an output terminal O1. The signal readout unit RU1 includes a transfer transistor G1, a floating diffusion FD1, a charge accumulation capacitor C1, a reset transistor RT1, a source follower transistor SF1, and a select transistor SL1. The charge accumulation unit CS1 is configured with the floating diffusion FD1 and the charge accumulation capacitor C1. Signal readout units RU2 to RU4 also have the same configuration.

The photoelectric conversion element PD is an embedded photodiode that photoelectrically converts incident light to generate electric charges according to intensity of the incident light and accumulates the generated electric charges. The photoelectric conversion element PD may have any structure. The photoelectric conversion element PD may be, for example, a PN photodiode having a structure in which a P-type semiconductor and an N-type semiconductor are bonded together, or a PIN photodiode having a structure in which an I-type semiconductor is interposed between the P-type semiconductor and the N-type semiconductor. In addition, the photoelectric conversion element PD is not limited to the photodiode and may be, for example, a photogate type photoelectric conversion element.

The charge discharging transistor GD is a transistor for discarding electric charges generated in the photoelectric conversion element PD. When the charge discharging transistor GD is controlled to be in an on-state by the pixel driving circuit 322, the charge discharging transistor GD discards the electric charges generated in the photoelectric conversion element PD (that is, resets the photoelectric conversion element PD).

The pixel driving circuit 322 drives the pixels 321, distributes electric charges generated by photoelectrically converting incident light by using the photoelectric conversion element PD to each of the four charge accumulation units CS, and outputs each of voltage signals corresponding to the electric charge amount of the distributed electric charges to the pixel signal processing circuit 325.

For example, in driving the pixels 321, the pixel driving circuit 322 controls accumulation drive signals TX1 to TX4 corresponding to each of the charge accumulation units CS1 to CS4 to be sequentially activated in synchronization with an emission timing of the optical pulse PO. Accordingly, the transfer transistors G1 to G4 respectively corresponding to the charge accumulation units CS are sequentially turned on, and electric charges are distributed and accumulated in the corresponding charge accumulation units CS. Thereby, the electric charges are accumulated in the charge accumulation units CS1, CS2, CS3, and CS4 in ascending order.

The pixel 321 is not limited to the configuration including four signal readout units RU as shown in FIG. 3, and may have a configuration including a plurality of signal readout units RU. That is, the number of signal readout units RU (the charge accumulation units CS) included in the pixels arranged in the distance image sensor 32 may be two, three, or five or more.

In addition, FIG. 3 shows an example in which the charge accumulation unit CS is configured by the floating diffusion FD and the charge accumulation capacitor C. However, the charge accumulation unit CS may be configured by at least the floating diffusion FD, and the pixel 321 may not include the charge accumulation capacitor C.

In addition, although the pixel 321 having the configuration shown in FIG. 3 shows an example of the configuration including the charge discharging transistor GD, when it is not necessary to discard the electric charges accumulated (remaining) in the photoelectric conversion element PD, the charge discharging transistor GD may not be provided.

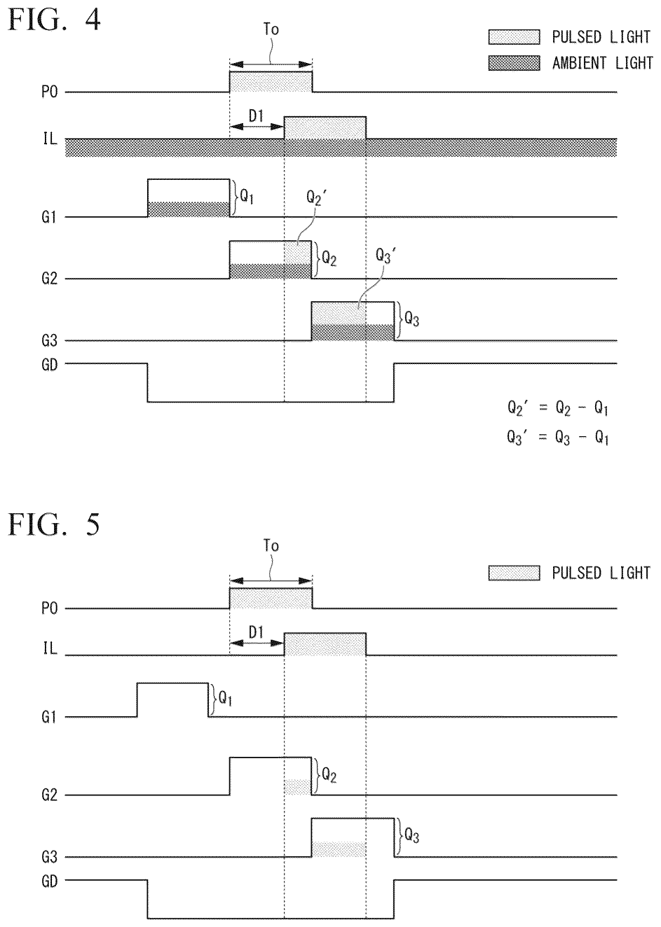

Here, a relationship between the configuration of the pixel 321, the driving according to the configuration, and a calculation equation for calculating a distance to a subject used according to the driving will be sequentially described with reference to FIGS. 4 to 10. FIGS. 4 to 10 are timing charts showing drive examples of the pixel 321.

Each of FIGS. 4 to 10 shows a timing chart of elements corresponding to respective items of “PO”, “IL”, “G1” to “G3” (or “G4”), and “GD”.

“PO” indicates an emission timing of the optical pulse PO, and light is emitted in an on-state (a state in which a timing signal is set to Hi), and the light is not emitted in an off-state (a state in which the timing signal is set to Lo).

“IL” indicates light incident on the pixel 321. When the optical pulse PO is emitted, the reflected light RL of the optical pulse PO is incident on the pixel 321 as “IL”. In addition, when a distance image is captured in an imaging environment where ambient light is present in the imaging environment, the ambient light is constantly incident on the pixels 321 as “IL”.

“G1” to “G3” (or “G4”) indicate a drive timing of the transfer transistors G1 to G3 (or G4), and electric charges are accumulated in the corresponding charge accumulation unit CS in the on-state, and the electric charges are not accumulated in the off-state. The drive timing is an example of an “accumulation timing”.

“GD” indicates a drive timing of the charge discharging transistor GD, and the electric charges generated in the photoelectric conversion element PD are discharged in the on-state, and the electric charges are not discharged in the off-state.

FIGS. 4 and 5 show timing charts showing examples in which the pixel 321 having a three-tap configuration is driven to perform measurement using one TW. The three-tap configuration is a configuration in which three charge accumulation units CS1 to CS3 are provided in the pixel 321. The measurement using one TW is a measurement in which an accumulation timing is set such that electric charges corresponding to the reflected light RL are accumulated in one set of charge accumulation unit CS groups constituting the TW (two charge accumulation units CS). The charge accumulation unit CS groups constituting the TW are two charge accumulation units CS that are successively driven. In the examples of FIGS. 4 and 5, the one set of charge accumulation unit CS groups constituting the TW are the charge accumulation units CS2 and CS3.

FIG. 4 shows an example of a case where measurement is performed in an imaging environment in which ambient light is incident on the distance image capturing device 1. The reflected light RL is incident on the distance image capturing device 1 after a delay time D1 elapses from emission of the optical pulse PO. Electric charges corresponding to the reflected light RL incident on the distance image capturing device 1 are accumulated in the charge accumulation units CS2 and CS3.

More specifically, in the example of FIG. 4, first, the charge discharging transistor GD is controlled to be in an off-state, and the transfer transistor G1 is controlled to be in an on-state. When accumulation time (for example, time To that is identical to emission time of the optical pulse PO) elapses after the transfer transistor G1 is controlled to be in the on-state, the transfer transistor G1 is controlled to be in the off-state. The optical pulse PO is emitted for the emission time To at a timing at which the transfer transistor G1 is controlled to be in the off-state. In addition, at the timing at which the transfer transistor G1 is controlled to be in the off-state, the transfer transistor G2 is controlled to be in the on-state. When the accumulation time elapses after the transfer transistor G2 is controlled to be in the on-state, the transfer transistor G2 is controlled to be in the off-state. At a timing at which the transfer transistor G2 is controlled to be in the off-state, the transfer transistor G3 is controlled to be in the on-state. When the accumulation time elapses after the transfer transistor G3 is controlled to be in the on-state, the transfer transistor G3 is controlled to be in the off-state, and the charge discharging transistor GD is controlled to be in the on-state.

The measurement control unit 43 controls the pixel driving circuit 322 to accumulate electric charges of one frame by repeatedly performing emission of the optical pulse PO and charge accumulation in the charge accumulation units CS1 to CS3 by a predetermined number of times of integration and to output the pixel signals Q₁ to Q₃ corresponding to the electric charge amounts of one frame accumulated in each of the charge accumulation units CS1 to CS3 to the distance calculation unit 42.

The distance calculation unit 42 calculates a distance to the subject OB by using a calculation equation shown in Equation (1-1). L is a distance to the subject OB. c is a speed of light. To is emission time at which the optical pulse PO is emitted. Q₁ to Q₃ are pixel signals respectively corresponding to the electric charge amounts accumulated in each of the charge accumulation units CS1 to CS3. In addition, Equation (1-1) can be represented as Equation (1-2). Q₂′ is a pixel signal corresponding to an electric charge amount corresponding to the amount of the reflected light RL included in the pixel signal Q₂. Q₃′ is a pixel signal corresponding to an electric charge amount corresponding to the amount of the reflected light RL included in the pixel signal Q₃.

$$L = \frac{1}{2} {cT}_{0} \frac{{Q}_{3} - {Q}_{1}}{( {Q}_{2} - {Q}_{1} ) + ( {Q}_{3} - {Q}_{1} )} \qquad ( 1 - 1 )$$

$$L = \frac{1}{2} {cT}_{0} \frac{{Q}_{3}^{′}}{{Q}_{2}^{′} + {Q}_{3}^{′}} \qquad ( 1 - 2 )$$

$${Q}_{2}^{′} = {Q}_{2} - {Q}_{1} \qquad ( 1 - 2 - 1 )$$

$${Q}_{3}^{′} = {Q}_{3} - {Q}_{1} \qquad ( 1 - 2 - 2 )$$

FIG. 5 shows an example of a case where the pixel 321 is driven in an imaging environment where ambient light is not incident on the distance image capturing device 1, for example, in a light-shielded space. In FIG. 5, timing of each of PO, IL, G1 to G3, and GD is the same as the timing in FIG. 4 except that the ambient light is not incident on the distance image capturing device 1, and thus, descriptions thereof will be omitted. In FIG. 5, since the ambient light is not incident on the pixel 321, only the reflected light RL is incident on the pixel 321 as “IL”.

In FIG. 5, as in FIG. 4, the reflected light RL is incident on the distance image capturing device 1 after the delay time D1 elapses from emission of the optical pulse PO. Electric charges corresponding to the reflected light RL incident on the distance image capturing device 1 are accumulated in the charge accumulation units CS2 and CS3.

The distance calculation unit 42 calculates a distance to the subject OB by using a calculation equation shown in Equation (2). L of Equation (2) is a distance to the subject OB. c is a speed of light. To is emission time at which the optical pulse PO is emitted. Q₂ and Q₃ are pixel signals corresponding to the electric charge amounts accumulated in each of the charge accumulation units CS2 and CS3.

$$L = \frac{1}{2} {cT}_{0} \frac{{Q}_{3}}{{Q}_{2} + {Q}_{3}} \qquad ( 2 )$$

Equation (2) corresponds to a case where pixel signal Q₁=0 is substituted into Equation (1). Both Equation (1) and Equation (2) have a relationship in which a proportionality constant (½×c×To) is multiplied by an electric charge ratio. The electric charge ratio is a ratio of an electric charge amount accumulated in the charge accumulation unit CS in the latter stage to the electric charge amount (total amount) corresponding to the reflected light RL. For example, when the electric charges corresponding to the reflected light RL are accumulated in the charge accumulation units CS2 and CS3, a denominator of the electric charge ratio is Q₂+Q₃ and a numerator is Q₃.

Hereinafter, for the sake of simple description, an imaging environment in which ambient light is not incident on the distance image capturing device 1, that is, a case where the pixel signal Q₁=0 will be described as an example. In this case, since the ambient light is not incident on the pixel 321, only the reflected light RL is incident on the pixel 321 as “IL”. However, the disclosure is not limited thereto, and can be applied to an imaging environment in which ambient light is incident on the distance image capturing device 1, that is, a case where the pixel signal Q₁≠0.

In addition, hereinafter, an accumulation timing is set such that electric charges corresponding to the ambient light are accumulated in the charge accumulation unit CS1. That is, the charge accumulation unit CS1 is used as a tap for the ambient light.

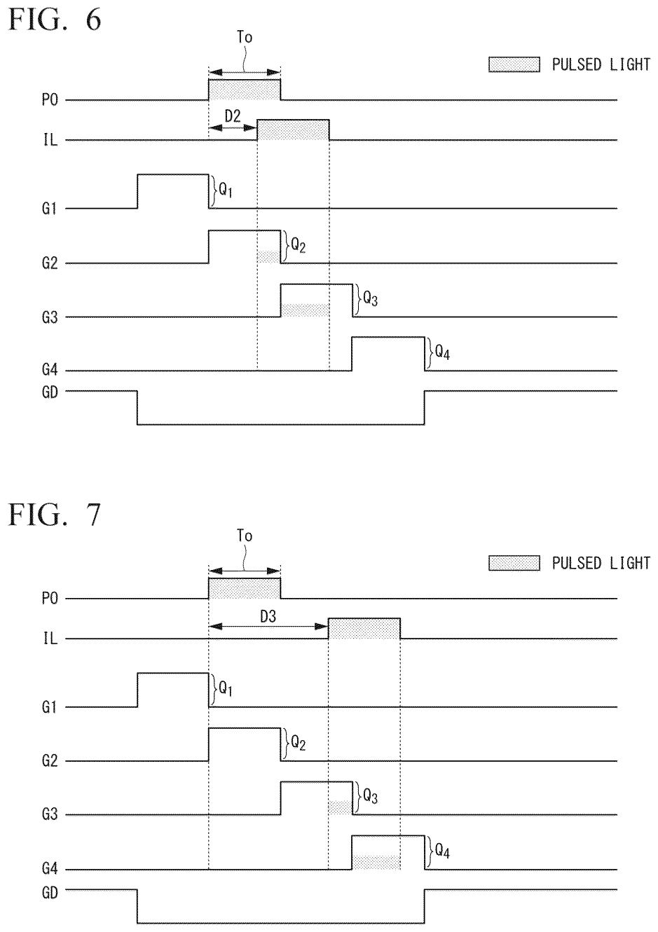

FIGS. 6 and 7 show timing charts showing examples in which the pixel 321 having a four-tap configuration is driven to perform measurement by using two TWs. The four-tap configuration is a configuration in which four charge accumulation units CS1 to CS4 are provided in the pixel 321. The measurement using two TWs is measurement in which the accumulation timing is set such that electric charges corresponding to the reflected light RL are accumulated in any of two sets of charge accumulation unit CS groups constituting the TW. The charge accumulation unit CS groups constituting the TW are two charge accumulation units CS that are successively driven. In the examples of FIGS. 6 and 7, the two sets of charge accumulation unit CS groups constituting the two TWs are a set of the charge accumulation units CS2 and CS3 which is a first TW and a set of the charge accumulation units CS3 and CS4 which is a second TW.

In FIG. 6, the reflected light RL is incident on the distance image capturing device 1 after a delay time D2 elapses from emission of the optical pulse PO. Electric charges corresponding to the reflected light RL incident on the distance image capturing device 1 are accumulated in the charge accumulation units CS2 and CS3.

More specifically, in the example of FIG. 6, first, the charge discharging transistor GD is controlled to be in an off-state, and the transfer transistor G1 is controlled to be in an on-state. When accumulation time (for example, time To that is identical to emission time of the optical pulse PO) elapses after the transfer transistor G1 is controlled to be in the on-state, the transfer transistor G1 is controlled to be in the off-state. The optical pulse PO is emitted for the emission time To at a timing at which the transfer transistor G1 is controlled to be in the off-state. In addition, at the timing at which the transfer transistor G1 is controlled to be in the off-state, the transfer transistor G2 is controlled to be in the on-state. When the accumulation time elapses after the transfer transistor G2 is controlled to be in the on-state, the transfer transistor G2 is controlled to be in the off-state. At a timing at which the transfer transistor G2 is controlled to be in the off-state, the transfer transistor G3 is controlled to be in the on-state. When the accumulation time elapses after the transfer transistor G3 is controlled to be in the on-state, the transfer transistor G3 is controlled to be in the off-state. At a timing at which the transfer transistor G3 is controlled to be in the off-state, the transfer transistor G4 is controlled to be in the on-state. When the accumulation time elapses after the transfer transistor G4 is controlled to be in the on-state, the transfer transistor G4 is controlled to be in the off-state, and the charge discharging transistor GD is controlled to be in the on-state.

When the electric charges corresponding to the reflected light RL are accumulated in the charge accumulation units CS2 and CS3 as shown in FIG. 6, the distance calculation unit 42 can calculate the distance to the subject OB by using a calculation equation shown in Equation (3-1). L of Equation (3-1) is the distance to the subject OB. c is a speed of light. To is emission time at which the optical pulse PO is emitted. Q₂ and Q₃ are pixel signals corresponding to the electric charge amounts accumulated in each of the charge accumulation units CS2 and CS3.

$$L = \frac{1}{2} {cT}_{0} \frac{{Q}_{3}}{{Q}_{2} + {Q}_{3}} \qquad ( 3 - 1 )$$

Equation (3-1) is equivalent to Equation (2) described above. That is, regardless of whether a configuration including one TW is provided or a configuration including two TWs is provided, when electric charges corresponding to the reflected light RL are accumulated in the charge accumulation units CS2 and CS3, the same calculation equation can be used.

In FIG. 7, the reflected light RL is incident on the distance image capturing device 1 after a delay time D3 elapses from emission of the optical pulse PO. The delay time D3 is greater than the delay time D2, and the electric charges corresponding to the reflected light RL incident on the distance image capturing device 1 are accumulated in the charge accumulation units CS3 and CS4. In FIG. 7, since timing of each of PO, IL, G1 to G3, and GD are the same as the timing in FIG. 6 except that the delay time D3 is greater than the delay time D2, description thereof will be omitted.

As shown in FIG. 7, when the electric charges corresponding to the reflected light RL are accumulated in the charge accumulation units CS3 and CS4, the distance calculation unit 42 can calculate the distance to the subject OB by using a calculation equation shown in Equation (3-2). In Equation (3-2), L is a distance to the subject OB. c is a speed of light. To is emission time at which the optical pulse PO is emitted. Q₃ and Q₄ are pixel signals corresponding to the electric charge amounts accumulated in each of the charge accumulation units CS3 and CS4.

$$L = \frac{1}{2} {cT}_{0} + \frac{1}{2} {cT}_{0} \frac{{Q}_{4}}{{Q}_{3} + {Q}_{4}} \qquad ( 3 - 2 )$$

Equation (3-2) is different from Equation (3-1) and Equation (2) described above. That is, in a case of the configuration including two TWs, it is necessary to use different calculation equations depending on a case where the reflected light RL is incident on the first TW and a case where the reflected light RL is incident on the second TW. The case where the reflected light RL is incident on the first TW is a case where the electric charges corresponding to the reflected light RL are accumulated in the charge accumulation units CS2 and CS3, and corresponds to a case where the subject OB is present at a short distance. The case where the reflected light RL is incident on the second TW is a case where the electric charges corresponding to the reflected light RL are accumulated in the charge accumulation units CS3 and CS4, and corresponds to a case where the subject OB is present at a long distance.

The fact that Equation (3-1) and Equation (3-2) are different calculation equations indicates that processing of determining which calculation equation is used is required in a process of calculating a distance. That is, when the distance to the subject OB is measured by using a plurality of TWs, it is necessary to perform the processing of determining which calculation equation is used depending on which TW the reflected light RL is incident. Therefore, there is a problem that processing is complicated.

As a countermeasure against this, in the present embodiment, even when the plurality of TWs are used, the distance can be calculated by using Equation (4) which is the same calculation equation. In Equation (4), L is a distance to the subject OB. c is a speed of light. To is emission time at which the optical pulse PO is emitted.

Q₂ to Q₄ are pixel signals corresponding to the electric charge amounts accumulated in each of the charge accumulation units CS2 to CS4.

$$L = \frac{1}{2} {cT}_{0} \frac{{Q}_{3} + {Q}_{4}}{{Q}_{2} + {Q}_{3} + {Q}_{4}} + \frac{1}{2} {cT}_{0} \frac{{Q}_{4}}{{Q}_{3} + {Q}_{4}} = \frac{1}{2} {cT}_{0} ( \frac{{Q}_{3} + {Q}_{4}}{{Q}_{2} + {Q}_{3} + {Q}_{4}} + \frac{{Q}_{4}}{{Q}_{3} + {Q}_{4}} ) \qquad ( 4 )$$

When the reflected light RL is incident on the second TW, that is, when the pixel signal Q₂ is 0 (zero), Equation (4) is Equation (4-1), which is equivalent to Equation (3-2) described above.

$${Q}_{2} = 0 \qquad ( 4 - 1 )$$

$$L = \frac{1}{2} {cT}_{0} ( \frac{{Q}_{3} + {Q}_{4}}{{Q}_{3} + {Q}_{4}} + \frac{{Q}_{4}}{{Q}_{3} + {Q}_{4}} ) = \frac{1}{2} {cT}_{0} ( 1 + \frac{{Q}_{4}}{{Q}_{3} + {Q}_{4}} ) = \frac{1}{2} {cT}_{0} + \frac{1}{2} {cT}_{0} \frac{{Q}_{4}}{{Q}_{3} + {Q}_{4}}$$

When the reflected light RL is incident on the first TW, that is, when the pixel signal Q₄ is 0 (zero), Equation (4) is Equation (4-2), which is equivalent to Equation (3-1) described above.

$${Q}_{4} = 0 \qquad ( 4 - 2 )$$

$$\begin{matrix}L = \frac{1}{2} {cT}_{0} ( \frac{{Q}_{3}}{{Q}_{2} + {Q}_{3}} + \frac{0}{{Q}_{3} + 0} ) \\ = \frac{1}{2} {cT}_{0} \frac{{Q}_{3}}{{Q}_{2} + {Q}_{3}} + \frac{1}{2} {cT}_{0} \frac{0}{{Q}_{3}} \\ = \frac{1}{2} {cT}_{0} \frac{{Q}_{3}}{{Q}_{2} + {Q}_{3}}\end{matrix}$$

That is, even in the configuration including two TWs, the distance to the subject OB can be calculated by using the same calculation equation (4) regardless of whether the reflected light RL is incident on the first TW or whether the reflected light RL is incident on the second TW.

Next, Equation (4) is expanded, and whether the pixel 321 having a five-tap configuration can be applied to measurement driven to perform the measurement by using three TWs can be examined.

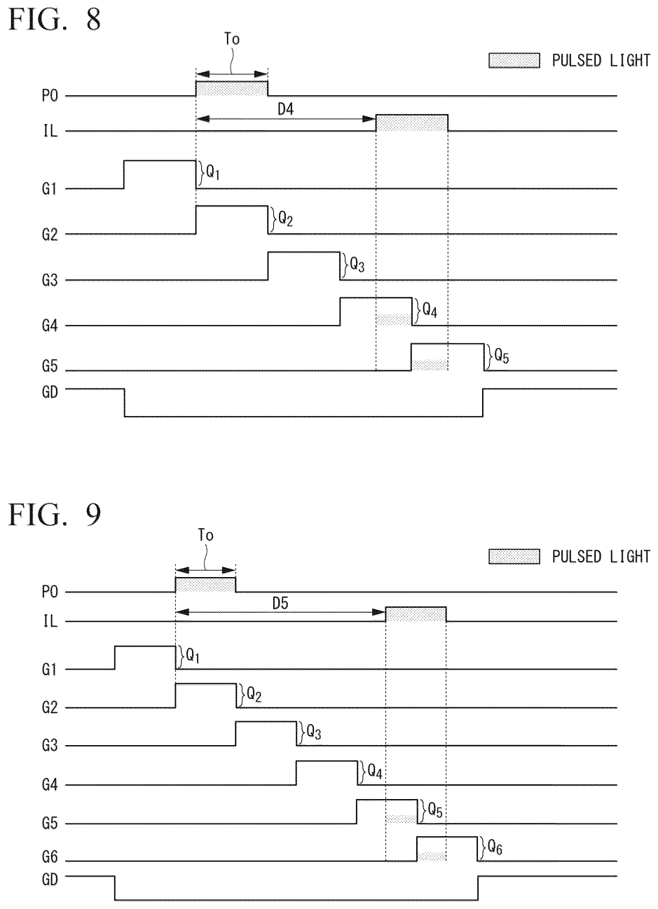

FIG. 8 shows a timing chart showing an example in which the pixel 321 having the five-tap configuration is driven to perform measurement by using the three TWs. The five-tap configuration is a configuration in which five charge accumulation units CS1 to CS5 are provided in the pixel 321. The measurement using the three TWs is measurement in which an accumulation timing is set such that the electric charges corresponding to the reflected light RL are accumulated in any of three sets of charge accumulation unit CS groups constituting the TW. The charge accumulation unit CS groups constituting the TW are two charge accumulation units CS that are successively driven. In the example of FIG. 8, the three sets of charge accumulation unit CS groups constituting the three TWs are a set of the charge accumulation units CS2 and CS3 that is the first TW, a set of the charge accumulation units CS3 and CS4 which is the second TW, and a set of the charge accumulation units CS4 and CS5 which is the third TW.

When measurement is performed by driving the pixel 321 having the five-tap configuration to perform the measurement by using the three TWs, whether the distance to the subject OB can be calculated by using a calculation equation shown in Equation (5) is examined.

$$L = \frac{1}{2} {cT}_{0} ( \frac{{Q}_{3} + {Q}_{4}}{{Q}_{2} + {Q}_{3} + {Q}_{4}} + \frac{{Q}_{4} + {Q}_{5}}{{Q}_{3} + {Q}_{4} + {Q}_{5}} + \frac{{Q}_{5}}{{Q}_{4} {Q}_{5}} ) \qquad ( 5 )$$

L of Equation (5) is a distance to the subject OB. c is a speed of light. To is emission time at which the optical pulse PO is emitted. Q₂ to Q₅ are pixel signals corresponding to the electric charge amounts accumulated in each of the charge accumulation units CS2 to CS5.

FIG. 8 shows an example in which, in measurement in which the pixel 321 having the five-tap configuration is driven to perform the measurement by using the three TWs, the reflected light RL is incident on the third TW. That is, an example is shown in which the reflected light RL is incident on the distance image capturing device 1 after a delay time D4 elapses from emission of the optical pulse PO, and the electric charges corresponding to the reflected light RL are accumulated in the charge accumulation units CS4 and CS5.

More specifically, in the example of FIG. 8, first, the charge discharging transistor GD is controlled to be in the off-state, and the transfer transistor G1 is controlled to be in the on-state. When accumulation time (for example, time To that is identical to emission time of the optical pulse PO) elapses after the transfer transistor G1 is controlled to be in the on-state, the transfer transistor G1 is controlled to be in the off-state. The optical pulse PO is emitted for the emission time To at a timing at which the transfer transistor G1 is controlled to be in the off-state. In addition, at the timing at which the transfer transistor G1 is controlled to be in the off-state, the transfer transistor G2 is controlled to be in the on-state. When the accumulation time elapses after the transfer transistor G2 is controlled to be in the on-state, the transfer transistor G2 is controlled to be in the off-state. At a timing at which the transfer transistor G2 is controlled to be in the off-state, the transfer transistor G3 is controlled to be in the on-state. When the accumulation time elapses after the transfer transistor G3 is controlled to be in the on-state, the transfer transistor G3 is controlled to be in the off-state. At a timing at which the transfer transistor G3 is controlled to be in the off-state, the transfer transistor G4 is controlled to be in the on-state. When the accumulation time elapses after the transfer transistor G4 is controlled to be in the on-state, the transfer transistor G4 is controlled to be in the off-state. At a timing at which the transfer transistor G4 is controlled to be in the off-state, the transfer transistor G5 is controlled to be in the on-state. When the accumulation time elapses after the transfer transistor G5 is controlled to be in the on-state, the transfer transistor G5 is controlled to be in the off-state and the charge discharging transistor GD is controlled to be in the on-state.

As shown in FIG. 8, when the electric charges corresponding to the reflected light RL are accumulated in the charge accumulation units CS4 and CS5, a signal corresponding to the reflected light RL is not included in both the pixel signal Q₂ and the pixel signal Q₃, and thus, a signal value is 0 (zero). When Q₂=Q₃=0 (zero) is substituted into Equation (5), Equation (5-1) is obtained, and the distance to the subject OB can be calculated. That is, when the third TW is used, the distance to the subject OB can be calculated by substituting a signal value of each pixel signal Q into Equation (5).

$${Q}_{2} = {Q}_{3} = 0 \qquad ( 5 - 1 )$$

$$\begin{matrix}L = \frac{1}{2} {cT}_{0} ( \frac{0 + {Q}_{4}}{0 + 0 + {Q}_{4}} + \frac{{Q}_{4} + {Q}_{5}}{0 + {Q}_{4} + {Q}_{5}} + \frac{{Q}_{5}}{{Q}_{4} + {Q}_{5}} ) \\ = \frac{1}{2} {cT}_{0} ( 1 + 1 + \frac{{Q}_{5}}{{Q}_{4} + {Q}_{5}} ) \\ = \frac{1}{2} {cT}_{0} + \frac{1}{2} {cT}_{0} + \frac{1}{2} {cT}_{0} ( \frac{{Q}_{5}}{{Q}_{4} + {Q}_{3}} )\end{matrix}$$

In measurement in which the pixel 321 having the five-tap configuration is driven to perform the measurement by using the three TWs, even when the reflected light RL is incident on the TW different from the third TW, it is further examined whether the distance to the subject OB can be calculated by using Equation (5).

In the measurement in which the pixel 321 having the five-tap configuration is driven to perform the measurement by using the three TWs, when the reflected light RL is incident on the first TW and the electric charges corresponding to the reflected light RL are accumulated in the charge accumulation units CS2 and CS3, the distance to the subject OB can be calculated by substituting Q₄=Q₅=0 (zero) into Equation (5). That is, when the first TW is used, the distance to the subject OB can be calculated by using Equation (5).

In measurement in which the pixel 321 having the five-tap configuration is driven to perform the measurement by using the three TWs, when the reflected light RL is incident on the second TW and the electric charges corresponding to the reflected light RL are accumulated in the charge accumulation units CS3 and CS4, the distance to the subject OB can be calculated by substituting Q₂=Q₅=0 (zero) into Equation (5). That is, when the second TW is used, the distance to the subject OB can be calculated by using Equation (5).

As described above, in the measurement using the three TWs, even when the reflected light RL is incident on any of the first TW to the third TW, the distance to the subject OB can be calculated by using Equation (5) that is the same calculation equation.

Next, Equation (5) is expanded, and whether the pixel 321 having a six-tap configuration can be applied to measurement driven to perform the measurement by using four TWs can be examined.

FIG. 9 shows a timing chart showing an example in which the pixel 321 having the six-tap configuration is driven to perform measurement by using four TWs. The six-tap configuration is a configuration in which six charge accumulation units CS1 to CS6 are provided in the pixel 321. The measurement using the four TWs is measurement in which an accumulation timing is set such that the electric charges corresponding to the reflected light RL are accumulated in any of four sets of charge accumulation unit CS groups constituting the TW. The charge accumulation unit CS groups constituting the TW are two charge accumulation units CS that are successively driven. In the example of FIG. 9, the four sets of charge accumulation unit CS groups constituting the four TWs are a set of the charge accumulation units CS2 and CS3 which is the first TW, a set of the charge accumulation units CS3 and CS4 which is the second TW, a set of the charge accumulation units CS4 and CS5 which is the third TW, and a set of the charge accumulation units CS5 and CS6 which is the fourth TW.

In measurement in which the pixel 321 having the six-tap configuration is driven to perform the measurement by using the four TWs, whether the distance to the subject OB can be calculated by using a calculation equation shown in Equation (6) obtained by expanding Equation (5) is examined.

$$L = \frac{1}{2} {cT}_{0} ( \frac{{Q}_{3} + {Q}_{4}}{{Q}_{2} + {Q}_{3} + {Q}_{4}} + \frac{{Q}_{4} + {Q}_{5}}{{Q}_{3} + {Q}_{4} + {Q}_{5}} + \frac{{Q}_{5} + {Q}_{6}}{{Q}_{4} + {Q}_{5} + {Q}_{6}} + \frac{{Q}_{6}}{{Q}_{5} + {Q}_{6}} ) \qquad ( 6 )$$

L of Equation (6) is a distance to the subject OB. c is a speed of light. To is emission time at which the optical pulse PO is emitted. Q₂ to Q₆ are pixel signals corresponding to the electric charge amounts accumulated in each of the charge accumulation units CS2 to CS6.

FIG. 9 shows an example in which, in measurement in which the pixel 321 having the six-tap configuration is driven to perform the measurement by using the four TWs, the reflected light RL is incident on the fourth TW. That is, an example is shown in which the reflected light RL is incident on the distance image capturing device 1 after a delay time D5 elapses from emission of the optical pulse PO, and the electric charges corresponding to the reflected light RL are accumulated in the charge accumulation units CS5 and CS6.

More specifically, in the example of FIG. 9, first, the charge discharging transistor GD is controlled to be in an off-state, and the transfer transistor G1 is controlled to be in an on-state. When accumulation time (for example, time To that is identical to emission time of the optical pulse PO) elapses after the transfer transistor G1 is controlled to be in the on-state, the transfer transistor G1 is controlled to be in the off-state. The optical pulse PO is emitted for the emission time To at a timing at which the transfer transistor G1 is controlled to be in the off-state. In addition, at the timing at which the transfer transistor G1 is controlled to be in the off-state, the transfer transistor G2 is controlled to be in the on-state. When the accumulation time elapses after the transfer transistor G2 is controlled to be in the on-state, the transfer transistor G2 is controlled to be in the off-state. At a timing at which the transfer transistor G2 is controlled to be in the off-state, the transfer transistor G3 is controlled to be in the on-state. When the accumulation time elapses after the transfer transistor G3 is controlled to be in the on-state, the transfer transistor G3 is controlled to be in the off-state. At a timing at which the transfer transistor G3 is controlled to be in the off-state, the transfer transistor G4 is controlled to be in the on-state. When the accumulation time elapses after the transfer transistor G4 is controlled to be in the on-state, the transfer transistor G4 is controlled to be in the off-state. At a timing at which the transfer transistor G4 is controlled to be in the off-state, the transfer transistor G5 is controlled to be in the on-state. When the accumulation time elapses after the transfer transistor G5 is controlled to be in the on-state, the transfer transistor G5 is controlled to be in the off-state. At a timing at which the transfer transistor G5 is controlled to be in the off-state, the transfer transistor G6 is controlled to be in the on-state. When the accumulation time elapses after the transfer transistor G6 is controlled to be in the on-state, the transfer transistor G6 is controlled to be in the off-state and the charge discharging transistor GD is controlled to be in the on-state.

As shown in FIG. 9, when the electric charges corresponding to the reflected light RL are accumulated in the charge accumulation units CS5 and CS6, the pixel signal Q₂=the pixel signal Q₃=the pixel signal Q₄=0 (zero). When Q₂=Q₃=Q₄=0 (zero) is substituted into Equation (6), Equation (6-1) is obtained.

In Equation (6-1), a denominator of the first term in the parentheses is 0 (zero), and thus, the distance to the subject OB may not be calculated. That is, when the fourth TW is used, the distance to the subject OB may not be calculated by using Equation (6).

$${Q}_{2} = {Q}_{3} = {Q}_{4} = 0 \qquad ( 6 - 1 )$$

$$\begin{matrix}L = \frac{1}{2} {cT}_{0} ( \frac{0 + 0}{0 + 0 + 0} + \frac{0 + {Q}_{5}}{0 + 0 + {Q}_{5}} + \frac{{Q}_{5} + {Q}_{6}}{0 + {Q}_{5} + {Q}_{6}} ) + \frac{{Q}_{6}}{{Q}_{5} + {Q}_{6}} ) \\ = \frac{1}{2} {cT}_{0} ( \frac{0}{0} + 1 + 1 + \frac{{Q}_{6}}{{Q}_{5} + {Q}_{6}} ) \\ = \frac{1}{2} {cT}_{0} ( \frac{0}{0} ) + \frac{1}{2} {cT}_{0} + \frac{1}{2} {cT}_{0} + \frac{1}{2} {cT}_{0} ( \frac{{Q}_{6}}{{Q}_{5} + {Q}_{6}} )\end{matrix}$$

Here, even when the reflected light RL is incident on any of the first TW to the fourth TW, a configuration is examined in which a denominator of each term in a calculation equation is not 0 (zero).

As described above, the distance to the subject GB can be calculated by multiplying an electric charge ratio by a proportionality constant (½×c×To). The electric charge ratio is a ratio of an electric charge amount accumulated in the charge accumulation unit CS in the latter stage to the electric charge amount (total amount) corresponding to the reflected light RL. In other words, the denominator of each term in parentheses corresponding to the electric charge ratio in the calculation equation is the electric charge amount (total amount) corresponding to the reflected light RL.

In Equation (6-1), the distance to the subject OB may not be calculated due to the fact that a pixel signal Q in a denominator of the first term in parentheses does not include the pixel signal Q corresponding to the reflected light RL.

In order to solve this problem, in the present embodiment, even when the electric charges corresponding to the reflected light RL are accumulated in any of the charge accumulation units CS, the pixel signal Q corresponding to the reflected light RL is included in a denominator of an electric charge ratio in a calculation equation. Specifically, the denominator of the electric charge ratio in the calculation equation is the sum of all pixel signals Q that can be the pixel signal Q corresponding to the reflected light RL. More specifically, when the pixel 321 having the six-tap configuration is driven to perform measurement by using four TWs, the distance to the subject OB is calculated by using the calculation equation shown in Equation (7).

$$L = \frac{1}{2} {cT}_{0} ( \frac{{Q}_{3} + {Q}_{4} + {Q}_{5} + {Q}_{6}}{{Q}_{2} + {Q}_{3} + {Q}_{4} + {Q}_{5} + {Q}_{6}} + \frac{{Q}_{4} + {Q}_{5} + {Q}_{6}}{{Q}_{2} + {Q}_{3} + {Q}_{4} + {Q}_{5} + {Q}_{6}} + \frac{{Q}_{5} + {Q}_{6}}{{Q}_{2} + {Q}_{3} + {Q}_{4} + {Q}_{5} + {Q}_{6}} + \frac{{Q}_{6}}{{Q}_{2} + {Q}_{3} + {Q}_{4} + {Q}_{5} + {Q}_{6}} \qquad ( 7 )$$

L of Equation (7) is a distance to the subject OB. c is a speed of light. To is emission time at which the optical pulse PO is emitted. Q₂ to Q₆ are pixel signals corresponding to the electric charge amounts accumulated in each of the charge accumulation units CS2 to CS6.

In Equation (7), when 0 (zero) is substituted into a signal value of each of the pixel signal Q₂, the pixel signal Q₃, and the pixel signal Q₄ by applying the example of FIG. 9, that is, a case where the electric charges corresponding to the reflected light RL are accumulated in the charge accumulation units CS5 and CS6, Equation (7-1) is obtained, and thus, the distance to the subject OB can be calculated without a denominator being 0 (zero). That is, in the configuration including four TWs, when the fourth TW is used, the distance to the subject OB can be calculated by substituting the signal value of each pixel signal Q into Equation (7).

$${Q}_{2} = {Q}_{3} = {Q}_{4} = 0 \qquad ( 7 - 1 )$$

$$\begin{matrix}L = \begin{matrix}\frac{1}{2} {cT}_{0} ( \frac{0 + 0 + {Q}_{5} + {Q}_{6}}{0 + 0 + 0 + {Q}_{5} + {Q}_{6}} + \frac{0 + {Q}_{5} + {Q}_{6}}{0 + 0 + 0 + {Q}_{5} + {Q}_{6}} + \\ \frac{{Q}_{5} + {Q}_{6}}{0 + 0 + 0 + {Q}_{5} + {Q}_{6}} + \frac{{Q}_{6}}{0 + 0 + 0 + {Q}_{5} + {Q}_{6}} )\end{matrix} \\ = \frac{1}{2} {cT}_{0} + \frac{1}{2} {cT}_{0} + \frac{1}{2} {cT}_{0} + \frac{1}{2} {cT}_{0} ( \frac{{Q}_{6}}{{Q}_{5} + {Q}_{6}} )\end{matrix}$$

In measurement in which the pixel 321 having the six-tap configuration is driven to perform the measurement by using the four TWs, even when the reflected light RL is incident on the TW different from the fourth TW, whether the distance to the subject OB can be calculated by using Equation (7) can be further examined.

In the measurement in which the pixel 321 having the six-tap configuration is driven to perform the measurement by using four TWs, when the reflected light RL is incident on the first TW and the electric charges corresponding to the reflected light RL are accumulated in the charge accumulation units CS2 and CS3, the distance to the subject OB can be calculated by substituting Q₄=Q₅=Q₆=0 (zero) into Equation (7). That is, when the first TW is used, the distance to the subject OB can be calculated by using Equation (7).

In the measurement in which the pixel 321 having the six-tap configuration is driven to perform the measurement by using four TWs, when the reflected light RL is incident on the second TW and the electric charges corresponding to the reflected light RL are accumulated in the charge accumulation units CS3 and CS4, the distance to the subject OB can be calculated by substituting Q₂=Q₅=Q₆=0 (zero) into Equation (7). That is, when the second TW is used, the distance to the subject OB can be calculated by using Equation (7).

In the measurement in which the pixel 321 having the six-tap configuration is driven to perform the measurement by using the four TWs, when the reflected light RL is incident on the third TW and the electric charges corresponding to the reflected light RL are accumulated in the charge accumulation units CS4 and CS5, the distance to the subject OB can be calculated by substituting Q₂=Q₃=Q₆=0 (zero) into Equation (7). That is, when the third TW is used, the distance to the subject OB can be calculated by using Equation (7).

That is, in the configuration including the four TWs, even when the reflected light RL is incident on any of the first TW to the fourth TW, the distance to the subject OB can be calculated by using Equation (7) which is the same calculation equation.

Next, Equation (7) is expanded, and whether Equation (7) can be applied as a calculation equation when being sub-frame-driven is examined.

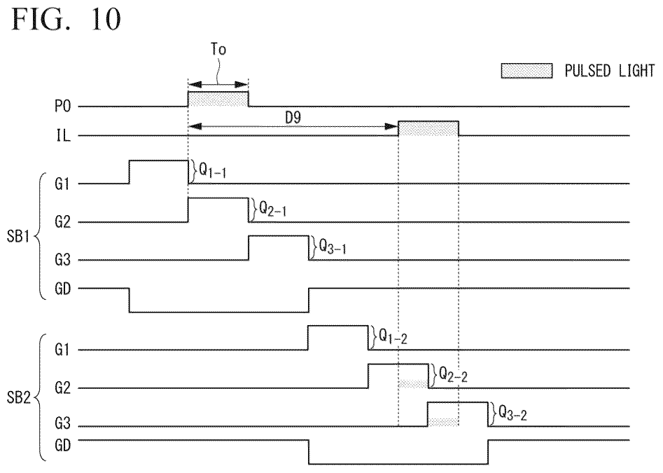

FIG. 10 shows a timing chart showing an example in which the pixel 321 having the three-tap configuration is configured to have four TWs by being sub-frame-driven. In the example of FIG. 10, in a first sub-frame SB1, the charge accumulation units CS1 to CS3 are driven at the same accumulation timing as in FIG. 5. In a second sub-frame SB2, the charge accumulation units CS1 to CS3 are driven at an accumulation timing different from the timings in the first sub-frame SB1.

In the example of FIG. 10, the measurement using four TWs is performed by combining the first sub-frame SB1 with the second sub-frame SB2. Four sets of the charge accumulation unit CS groups constituting the TW are a set of the charge accumulation units CS2 and CS3 in the first sub-frame SB1 functioning as the first TW, a set of the charge accumulation unit CS3 in the first sub-frame SB1 and the charge accumulation unit CS1 in the second sub-frame SB2 functioning as the second TW, a set of the charge accumulation units CS1 and CS2 in the second sub-frame SB2 functioning as the third TW, and a set of the charge accumulation units CS2 and CS3 in the second sub-frame SB2 functioning as the fourth TW.

In the configuration including the four TWs by sub-frame-driving the configuration including the three taps, whether the distance to the subject OB can be calculated is examined by using the calculation equation shown in Equation (8) obtained by expanding Equation (7).

$$L = \frac{1}{2} {cT}_{0} ( \frac{{Q}_{3 − 1} + {Q}_{1 - 2} + {Q}_{2 - 2} + {Q}_{3 - 2}}{{Q}_{2 - 1} + {Q}_{3 - 1} + {Q}_{1 - 2} + {Q}_{2 - 2} + {Q}_{3 - 2}} + \frac{{Q}_{1 − 2} + {Q}_{2 - 2} + {Q}_{3 - 2}}{{Q}_{2 - 1} + {Q}_{3 - 1} + {Q}_{1 - 2} + {Q}_{2 - 2} + {Q}_{3 - 2}} + \frac{{Q}_{2 - 2} + {Q}_{3 - 2}}{{Q}_{2 - 1} + {Q}_{3 - 1} + {Q}_{1 - 2} + {Q}_{2 - 2} + {Q}_{3 - 2}} + \frac{{Q}_{3 - 2}}{{Q}_{2 - 1} + {Q}_{3 - 1} + {Q}_{1 - 2} + {Q}_{2 - 2} + {Q}_{3 - 2}} \qquad ( 8 )$$

L of Equation (8) is a distance to the subject OB. c is a speed of light. To is emission time at which the optical pulse PG is emitted. Q₁₋₁, Q₂₋₁, and Q₃₋₁ are pixel signals corresponding to the electric charge amounts accumulated in each of the charge accumulation units CS1, CS2, and CS3, in the first sub-frame SB1. Q₁₋₂, Q₂₋₂, and Q₃₋₂ are pixel signals corresponding to the electric charge amounts accumulated in each of the charge accumulation units CS1, CS2, and CS3, in the second sub-frame SB2.

FIG. 10 shows an example in which the electric charges corresponding to the reflected light RL are accumulated in the charge accumulation units CS2 and CS3 in the second sub-frame SB2.

More specifically, in the example of FIG. 10, first, in the first sub-frame SB1, the charge discharging transistor GD is controlled to be in an off-state, and the transfer transistor G1 is controlled to be in an on-state. When accumulation time (for example, time To that is identical to emission time of the optical pulse PO) elapses after the transfer transistor G1 is controlled to be in the on-state, the transfer transistor G1 is controlled to be in the off-state. The optical pulse PO is emitted for the emission time To at a timing at which the transfer transistor G1 is controlled to be in the off-state. In addition, at the timing at which the transfer transistor G1 is controlled to be in the off-state, the transfer transistor G2 is controlled to be in the on-state. When the accumulation time elapses after the transfer transistor G2 is controlled to be in the on-state, the transfer transistor G2 is controlled to be in the off-state. At a timing at which the transfer transistor G2 is controlled to be in the off-state, the transfer transistor G3 is controlled to be in the on-state. When the accumulation time elapses after the transfer transistor G3 is controlled to be in the on-state, the transfer transistor G3 is controlled to be in the off-state, and the charge discharging transistor GD is controlled to be in the on-state. In the first sub-frame SB1, pixel signals corresponding to the electric charge amounts accumulated in the charge accumulation units CS1, CS2, and CS3 are output as pixel signals Q₁₋₁, Q₂₋₁, and Q₃₋₁.

Next, in the second sub-frame SB2, the optical pulse PO is emitted for an emission time To.

The charge discharging transistor GD is controlled to be in the off-state and the transfer transistor G1 is controlled to be in the on-state at a timing at which predetermined time (for example, time To×2 that is the same as the emission time of the optical pulse PO) elapses from a timing at which the optical pulse PO is emitted for the emission time To. When accumulation time (for example, time To that is identical to emission time of the optical pulse PO) elapses after the transfer transistor G1 is controlled to be in the on-state, the transfer transistor G1 is controlled to be in the off-state. At a timing at which the transfer transistor G1 is controlled to be in the off-state, the transfer transistor G2 is controlled to be in the on-state. When the accumulation time elapses after the transfer transistor G2 is controlled to be in the on-state, the transfer transistor G2 is controlled to be in the off-state. At a timing at which the transfer transistor G2 is controlled to be in the off-state, the transfer transistor G3 is controlled to be in the on-state. When the accumulation time elapses after the transfer transistor G3 is controlled to be in the on-state, the transfer transistor G3 is controlled to be in the off-state, and the charge discharging transistor GD is controlled to be in the on-state. In the second sub-frame SB2, the pixel signals corresponding to the electric charge amounts accumulated in the charge accumulation units CS1, CS2, and CS3 are output as pixel signals Q₁₋₂, Q₂₋₂, and Q₃₋₂.

As shown in FIG. 10, when the three-tap configuration is sub-frame-driven and the electric charges corresponding to the reflected light RL are accumulated in the charge accumulation units CS2 and CS3 in the second sub-frame SB2, signal values of the pixel signals Q₂₋₁, Q₃₋₁, and Q₁₋₂ are 0 (zero). By substituting 0 (zero) into Q₂₋₁, Q₃₋₁, and Q₁₋₂ of Equation (8), Equation (8-1) is obtained, and the distance to the subject OB can be calculated.

$$L = ( 1 / 2 \times c \times To ) \cdot \{ 1 + 1 + 1 + {Q}_{3 - 2} / ( {Q}_{2 - 2} + {Q}_{3 - 2} ) \} \qquad ( 8 - 1 )$$

When the three-tap configuration is sub-frame-driven, even when the reflected light RL is incident at a timing different from the timing in FIG. 10, whether the distance to the subject OB can be calculated by using Equation (8) is examined.

When the electric charges corresponding to the reflected light RL are accumulated in the charge accumulation units CS2 and CS3 in the first sub-frame SB1, the distance to the subject OB can be calculated by substituting Q₁₋₂=Q₂₋₂=Q₃₋₂=0 (zero) into Equation (8). That is, even when the electric charges corresponding to the reflected light RL are accumulated in the charge accumulation units CS2 and CS3 in the first sub-frame SB1, the distance to the subject OB can be calculated by using Equation (8).

When the electric charges corresponding to the reflected light RL are accumulated in the charge accumulation unit CS3 in the first sub-frame SB1 and the charge accumulation unit CS1 in the second sub-frame SB2, the distance to the subject OB can be calculated by substituting Q₂₋₁=Q₂₋₂=Q₃₋₂=0 (zero) into Equation (8). That is, even when the electric charges are accumulated in the charge accumulation unit CS3 in the first sub-frame SB1 and the charge accumulation unit CS1 in the second sub-frame SB2, the distance to the subject OB can be calculated by using Equation (8).

When the electric charges corresponding to the reflected light RL are accumulated in the charge accumulation units CS1 and CS2 in the second sub-frame SB2, the distance to the subject OB can be calculated by substituting Q₂₋₁=Q₃₋₁=Q₃₋₂=0 (zero) into Equation (8). That is, even when the electric charges are accumulated in the charge accumulation unit CS3 in the first sub-frame SB1 and the charge accumulation unit CS1 in the second sub-frame SB2, the distance to the subject OB can be calculated by using Equation (8).

That is, when the three-tap configuration is sub-frame-driven and has a configuration including four TWs, even when measurement is performed by using any of the first TW to the fourth TW, the distance to the subject OB can be calculated by using Equation (8) which is the same calculation equation.

Further, following the concept used in the term of a denominator in an electric charge ratio of Equation (7), Equation (9) can be derived as a calculation equation that can be applied to measurement in which the pixel 321 having n-tap configuration is driven to perform the measurement by using (n−2) TWs.

$$( 9 )$$

$$L = \frac{1}{2} {cT}_{0} ( \frac{{Q}_{3} + {Q}_{4} + … + {Q}_{n - 1} + {Q}_{n}}{{Q}_{2} + {Q}_{3} + {Q}_{4} + … + {Q}_{n - 1} + {Q}_{n}} + \frac{{Q}_{4} + … + {Q}_{n - 1} + {Q}_{n}}{{Q}_{2} + {Q}_{3} + {Q}_{4} + … + {Q}_{n - 1} + {Q}_{n}} + \frac{{Q}_{n - 1} + {Q}_{n}}{{Q}_{2} + {Q}_{3} + {Q}_{4} + … + {Q}_{n - 1} + {Q}_{n}} + \frac{{Q}_{n}}{{Q}_{2} + {Q}_{3} + {Q}_{4} + … + {Q}_{n - 1} + {Q}_{n}}$$

n of Equation (9) is an integer of 5 or more. L is a distance to the subject OB. c is a speed of light. To is emission time at which the optical pulse PO is emitted. Q₂ to Qₙ are pixel signals corresponding to the electric charge amounts accumulated in each of the charge accumulation units CS2 to CSn.

The following driving is assumed as a driving method when a distance is calculated by using Equation (9). First, the charge discharging transistor GD is controlled to be in an off-state, and the transfer transistor G1 is controlled to be in an on-state. When accumulation time (for example, time To that is identical to emission time of the optical pulse PO) elapses after the transfer transistor G1 is controlled to be in the on-state, the transfer transistor G1 is controlled to be in the off-state. The optical pulse PO is emitted for the emission time To at a timing at which the transfer transistor G1 is controlled to be in the off-state. In addition, at the timing at which the transfer transistor G1 is controlled to be in the off-state, the transfer transistor G2 is controlled to be in the on-state. When the accumulation time elapses after the transfer transistor G2 is controlled to be in the on-state, the transfer transistor G2 is controlled to be in the off-state. At a timing at which the transfer transistor G2 is controlled to be in the off-state, the transfer transistor G3 is controlled to be in the on-state. In this way, the transfer transistors G3, G4, . . . , and Gn are controlled to be sequentially in the on-state for a predetermined accumulation time, the transfer transistor Gn is controlled to be in the off-state, and the charge discharging transistor GD is controlled to be in the on-state.

The equation (9) can be derived by applying the concept of multiplying an electric charge ratio by a proportionality constant (½×c×To) to the n-tap configuration. As described above, the electric charge ratio is a ratio of the electric charge amount accumulated in the charge accumulation unit CS in the latter stage to an electric charge amount (total amount) corresponding to the reflected light RL.

A denominator of the electric charge ratio in the n-tap configuration is the electric charge amount (total amount) corresponding to the reflected light RL, and thus, the denominator can be represented as a denominator of each term in parentheses of Equation (9).

A numerator of the electric charge ratio in the n-tap configuration is the electric charge amount accumulated in the charge accumulation unit CS in the latter stage. For example, when the reflected light RL is incident on the first TW configured by the charge accumulation units CS2 and CS3, the electric charge amount accumulated in the charge accumulation unit CS in the latter stage is a value corresponding to the pixel signal Q₃. The pixel signal Q₃ is equivalent to (Q₃+Q₄+ . . . +Qₙ), which is a numerator of the first term in parentheses of Equation (9). When the reflected light RL is incident on the first TW, all of the pixel signals Q₄, . . . , and Qₙ are 0 (zero), and (Q₄= . . . +Qₙ) is 0 (zero). Since all of the pixel signals Q₄, . . . , Q₁ are 0 (zero), all of the second and subsequent terms in parentheses of Equation (9) are 0 (zero). That is, when the reflected light RL is incident on the first TW, the distance to the subject OB can be calculated by using Equation (9).

When the reflected light RL is incident on the second TW configured by the charge accumulation units CS3 and CS4, the electric charge amount accumulated in the charge accumulation unit CS in the latter stage is a value corresponding to the pixel signal Q₄. The pixel signal Q₄ is equivalent to (Q₄+ . . . +Qₙ), which is a numerator of the second term in the parentheses of Equation (9). This is because, when the reflected light RL is incident on the second TW, all of the pixel signals Q₅, . . . , and Qₙ are 0 (zero), and (Q₅+ . . . +Qₙ) is 0 (zero). Since all of the pixel signals Q₅, . . . , and Qₙ are 0 (zero), all of the third and subsequent terms in the parentheses of Equation (9) are 0 (zero). In addition, when the reflected light RL is incident on the second TW, the pixel signal Q₂ is 0 (zero), and thus, the first term in the parentheses of Equation (9) is 1. This corresponds to an offset distance (½×c×To) caused by incidence of the reflected light RL on the second TW instead of the first TW. When the reflected light RL is incident on the second TW, a distance obtained by adding the offset distance to the distance calculated based on the electric charge ratio corresponds to the distance to the subject OB. That is, when the reflected light RL is incident on the second TW, the distance to the subject OB can be calculated by using Equation (9).

The same concept can be applied to a case where the reflected light RL is incident on the third TW configured by the charge accumulation units CS4 and CS5 and a case where the reflected light RL is incident on the fourth TW configured by the charge accumulation units CS5 and CS6. That is, even when the reflected light RL is incident on the third TW and a case where the reflected light RL is incident on the fourth TW, the distance to the subject OB can be calculated by using Equation (9).

When Equation (9) is generalized, Equation (10) can be obtained.

$$L = \frac{1}{2} {cT}_{0} \frac{{\sum }_{k = 3}^{n} ( {\sum }_{i = k}^{n} {Q}_{i} )}{{\sum }_{i = 2}^{n} {Q}_{i}} \qquad ( 10 )$$

n of Equation (10 is an integer greater than or equal to 3. L is a distance to the subject OB. c is a speed of light. To is emission time at which the optical pulse PO is emitted. Q₂ to Qₙ are pixel signals corresponding to the electric charge amounts accumulated in each of the charge accumulation units CS2 to CSn.

Although the above-described embodiment describes, as an example, a case where the charge accumulation unit CS1 is used as a tap for ambient light, the charge accumulation unit CS1 can also be used as a tap for accumulating electric charges corresponding to the reflected light RL without being used as a tap for ambient light. In this case, Equation (11) can be used as a calculation equation that can be applied to measurement in which the pixel 321 having the n-tap configuration is driven to perform the measurement by using (n−1) TWs.

$$L = \frac{1}{2} {cT}_{0} \frac{{\sum }_{k = 2}^{n} ( {\sum }_{i = k}^{n} {Q}_{i} )}{{\sum }_{i = 2}^{n} {Q}_{i}} \qquad ( 11 )$$

n of Equation (11) is an integer greater than or equal to 2. L is a distance to the subject OB. c is a speed of light. To is emission time at which the optical pulse PO is emitted. Q₂ to Qₙ are pixel signals corresponding to the electric charge amounts accumulated in each of the charge accumulation units CS2 to CSn.

In a configuration in which a distance is calculated by using Equation (11), the charge accumulation unit CS1 is not used as a tap for ambient light. Instead, for example, a signal value of a pixel signal corresponding to ambient light can be calculated from the pixel signal Q obtained by performing the driving in another frame such that only the ambient light is incident without emitting the optical pulse PO.

The following driving is assumed as a driving method of the pixel 321 when a distance is calculated by using Equation (11). First, the optical pulse PO is emitted for an emission time To. At a timing at which emission of the optical pulse PO is started, the charge discharging transistor GD is controlled to be in an off-state, and the transfer transistor G1 is controlled to be in an on-state. When accumulation time (for example, time To that is identical to emission time of the optical pulse PO) elapses after the transfer transistor G1 is controlled to be in the on-state, the transfer transistor G1 is controlled to be in the off-state. At a timing at which the transfer transistor G1 is controlled to be in the off-state, the transfer transistor G2 is controlled to be in the on-state. When the accumulation time elapses after the transfer transistor G2 is controlled to be in the on-state, the transfer transistor G2 is controlled to be in the off-state. At a timing at which the transfer transistor G2 is controlled to be in the off-state, the transfer transistor G3 is controlled to be in the on-state. In this way, the transfer transistors G3, G4, . . . , and Gn are controlled to be sequentially in the on-state for a predetermined accumulation time, the transfer transistor Gn is controlled to be in the off-state, and the charge discharging transistor GD is controlled to be in the on-state.

As described above, the distance image capturing device 1 according to an embodiment includes the light source unit 2, the light receiving unit 3, and the distance calculation unit 42. The light source unit 2 emits the optical pulse PO to the subject OB. The light receiving unit 3 includes the distance image sensor 32 (pixel circuit) in which a plurality of pixels 321, each having the photoelectric conversion element PD and three or more charge accumulation units CS, are arranged in two-dimensional matrix form, and the pixel driving circuit 322. The photoelectric conversion element PD generates electric charges according to incident light. The charge accumulation unit CS accumulates the electric charges. The pixel driving circuit 322 distributes electric charges to each of the charge accumulation units CS at an accumulation timing synchronized with an emission timing at which the optical pulse PO is emitted, and accumulates the electric charges in the charge accumulation units CS.

The distance calculation unit 42 calculates a distance to a subject OB based on electric charge amounts accumulated in each of the charge accumulation units CS. A relationship between an emission timing and an accumulation timing is set such that electric charges corresponding to reflected light RL (reflected light of the optical pulse PO which is reflected from the subject OB) are accumulated in any two charge accumulation units CS, in which the electric charges are successively accumulated, among three or more charge accumulation units CS provided in the pixels 321. The distance calculation unit 42 calculates the distance to the subject OB by using the same calculation equation (for example, Equation (10) or Equation (11)), regardless of which of the three or more charge accumulation units CS provided in the pixel 321 accumulates the electric charges corresponding to the reflected light RL. Thereby, the distance image capturing device 1 of the embodiment can calculate a distance to a subject OB by using the same calculation equation regardless of which two of the three or more charge accumulation units CS accumulate the electric charges corresponding to the reflected light RL, that is, which of the three or more charge accumulation units CS accumulates the electric charges corresponding to the reflected light RL when a plurality of TWs are used, that is, which of the plurality of TWs is used. Accordingly, it is possible to calculate a distance to a subject without performing processing of any determination or case division, such as using different calculation equations according to a timing at which the reflected light RL is incident. Therefore, when measurement is performed by using a plurality of TWs, processing of calculating a distance to a subject can be simplified.

In addition, in the distance image capturing device 1 of the embodiment, the pixels 321 include n (n≥3) or more charge accumulation units CS, that are, the charge accumulation unit CS1 (first accumulation unit), the charge accumulation unit CS2 (second accumulation unit), . . . , and the charge accumulation unit CSn (nth accumulation unit). Electric charges are accumulated in the charge accumulation units CS1, CS2, . . . , and CSn in ascending order. A relationship between an emission timing and an accumulation timing is set such that electric charges corresponding to the reflected light RL are accumulated in a set of charge accumulation units CS (any two charge accumulation units CS and two charge accumulation units CS in which electric charges are successively accumulated) constituting TW among n charge accumulation units CS including the charge accumulation units CS1, CS2, . . . , and CSn. The distance calculation unit 42 calculates a distance to the subject OB by using Equation (11) as a calculation equation. Thereby, in the distance image capturing device 1 of an embodiment, in a configuration of three or more taps, that is, a configuration in which three or more charge accumulation units CS are used, the charge accumulation unit CS1 is driven so as not to be used as a tap for ambient light, and in a configuration in which two or more TWs are used, a distance to the subject OB can be calculated by using Equation (11) which is the same calculation equation regardless of which TW the reflected light RL is incident on.

In addition, in the distance image capturing device 1 of the embodiment, the pixels 321 include n (n≥4) or more charge accumulation units CS, that are, the charge accumulation unit CS1 (first accumulation unit), the charge accumulation unit CS2 (second accumulation unit), the charge accumulation unit CS3 (third accumulation unit), . . . , and the charge accumulation unit CSn (nth accumulation unit). Electric charges are accumulated in the charge accumulation units CS1, CS2, CS3, . . . , and CSn in ascending order. A relationship between an emission timing and an accumulation timing is set such that electric charges corresponding to the reflected light RL are accumulated in a set of charge accumulation units CS (any two charge accumulation units CS and two charge accumulation units CS in which electric charges are successively accumulated) constituting TW among (n−1) charge accumulation units CS including the charge accumulation units CS2, CS3, . . . , and CSn. The distance calculation unit 42 calculates a distance to the subject OB by using Equation (10) as a calculation equation. Thereby, in the distance image capturing device 1 of an embodiment, in a configuration of four or more taps, that is, a configuration in which four or more charge accumulation units CS are used, the charge accumulation unit CS1 is driven to be used as a tap for ambient light, and in a configuration in which two or more TWs are used, a distance to the subject OB can be calculated by using Equation (10 which is the same calculation equation regardless of which TW the reflected light RL is incident on.

In addition, in the distance image capturing device 1 of the embodiment, four charge accumulation units CS1 to CS4 are provided in the pixels 321. Electric charges are accumulated in the charge accumulation units CS1, CS2, CS3, and CS4 in ascending order. A relationship between an emission timing and an accumulation timing is set such that electric charges corresponding to the reflected light RL are accumulated in any of the charge accumulation units CS2, CS3, and CS4. The distance calculation unit 42 calculates a distance to the subject OB by using Equation (4) as a calculation equation. Thereby, in the distance image capturing device 1 of the embodiment, in a configuration of four or more taps, that is, a configuration in which four or more charge accumulation units CS are used, the charge accumulation unit CS1 is driven to be used as a tap for ambient light, and a configuration including two TWs can be achieved. When the reflected light RL is incident on the first TW, electric charges corresponding to the reflected light RL are accumulated in the charge accumulation units CS2 and CS3. When the reflected light RL is incident on the second TW, electric charges corresponding to the reflected light RL are accumulated in the charge accumulation units CS3 and CS4. As described above, even in a configuration in which two TWs are used, a distance to the subject OB can be calculated by using Equation (4) which is the same calculation equation regardless of which TW the reflected light RL is incident on.

All or a part of the distance image capturing device 1 and the distance image processing unit 4 according to the above-described embodiment may be implemented by a computer. In this case, a program for implementing the functions may be recorded on a computer-readable recording medium, and a computer system may read and execute a program recorded on the recording medium to implement the functions. A term “computer system” herein includes an OS and hardware such as a peripheral device. In addition, a term “computer-readable recording medium” refers to a storage device, for example, a portable medium such as a flexible disk, a magneto-optical disk, a ROM, or a CD-ROM, a hard disk built in a computer system, or the like. Furthermore, a term “computer-readable recording medium” may also include a thing that dynamically stores a program for a short period of time, such as a communication line when transmitting a program through a network such as the Internet or a communication line such as a telephone line, and a thing that stores a program for a certain period of time, such as a server or a volatile memory in a computer system that becomes a client in that case. In addition, the program may implement a part of the above-described function, may further implement the above-described functions in combination with a program previously recorded in a computer system, or may be executed by a programmable logic device such as an FPGA.

While preferred embodiments of the disclosure have been described and illustrated above, it should be understood that these are exemplary of the disclosure and are not to be considered as limiting. Additions, omissions, substitutions, and other modifications can be made without departing from the scope of the disclosure. Accordingly, the disclosure is not to be considered as being limited by the foregoing description and is only limited by the scope of the appended claims.

What is claimed is:

1. A distance image capturing device comprising:
a light source unit configured to emit an optical pulse to a subject;
a light receiving unit including a distance image sensor in which a plurality of pixels, each having a photoelectric conversion element that generates electric charges according to incident light and three or more charge accumulation units that accumulate electric charges, are arranged in a two-dimensional matrix form, and a pixel driving circuit configured to distribute electric charges to each of the charge accumulation units at an accumulation timing synchronized with an emission timing for emitting the optical pulse and accumulate the electric charges in each of the charge accumulation units; and
a distance calculation unit configured to calculate a distance to the subject based on an electric charge amount accumulated in each of the charge accumulation units,
wherein a relationship between the emission timing and the accumulation timing is set such that electric charges corresponding to reflected light of the optical pulse reflected from the subject are accumulated in any two charge accumulation units in which electric charges are successively accumulated, among the three or more charge accumulation units provided in the pixel, and
the distance calculation unit calculates the distance to the subject by using the same calculation equation regardless of which of the three or more charge accumulation units provided in the pixels accumulates the electric charges corresponding to the reflected light.

2. The distance image capturing device according to claim 1,
wherein the pixel includes a first accumulation unit, a second accumulation unit, . . . , and an nth accumulation unit which are n (n≥3) or more charge accumulation units,
electric charges are accumulated in the first accumulation unit, the second accumulation unit, . . . , and the nth accumulation unit in ascending order,
the relationship between the emission timing and the accumulation timing is set such that the electric charges corresponding to the reflected light are accumulated in any two charge accumulation units in which the electric charges are successively accumulated, among n charge accumulation units including the first accumulation unit, the second accumulation unit, . . . , and the nth accumulation unit, and
the distance calculation unit calculates the distance to the subject by using the following Equation (1) as the calculation equation,
$$L = \frac{1}{2} {cT}_{0} \frac{{\sum }_{k = 2}^{n} ( {\sum }_{i = k}^{n} {Q}_{i} )}{{\sum }_{i = 1}^{n} {Q}_{i}} \qquad ( 1 )$$
L: distance to subject
c: speed of light
T₀: emission time of optical pulse
n: number of charge accumulation units provided in pixel (n≥3)
Qₘ: pixel signal corresponding to electric charge amount accumulated in m-th charge accumulation unit
(m is any integer from 1 to n).

3. The distance image capturing device according to claim 1,
wherein the pixel includes a first accumulation unit, a second accumulation unit, a third accumulation unit, . . . , and an nth accumulation unit which are n (n≥4) or more charge accumulation units,
electric charges are accumulated in the first accumulation unit, the second accumulation unit, the third accumulation unit, . . . , and the nth accumulation unit in ascending order,
the relationship between the emission timing and the accumulation timing is set such that the electric charges corresponding to the reflected light are accumulated in any two charge accumulation units in which the electric charges are successively accumulated, among (n−1) charge accumulation units including the second accumulation unit, the third accumulation unit, . . . , and the nth accumulation unit, and
the distance calculation unit calculates the distance to the subject by using the following Equation (2) as the calculation equation,
$$L = \frac{1}{2} {cT}_{0} \frac{{\sum }_{k = 3}^{n} ( {\sum }_{i = k}^{n} {Q}_{i} )}{{\sum }_{i = 2}^{n} {Q}_{i}} \qquad ( 2 )$$
L: distance to subject
c: speed of light
T₀: emission time of optical pulse
n: number of charge accumulation units provided in pixel (n≥4)
Qₘ: pixel signal corresponding to electric charge amount accumulated in m-th charge accumulation unit
(m is any integer from 2 to n).

4. The distance image capturing device according to claim 1,
wherein the pixel includes four charge accumulation units including a first accumulation unit, a second accumulation unit, a third accumulation unit, and a fourth accumulation unit,
electric charges are accumulated in the first accumulation unit, the second accumulation unit, the third accumulation unit, and the fourth accumulation unit in ascending order,
the relationship between the emission timing and the accumulation timing is set such that the electric charges corresponding to the reflected light are accumulated in any two charge accumulation units in which the electric charges are successively accumulated, among the second accumulation unit, the third accumulation unit, and the fourth accumulation unit, and
the distance calculation unit calculates the distance to the subject by using the following Equation (3) as the calculation equation,
$$L = \frac{1}{2} {cT}_{0} \frac{{Q}_{3} + {Q}_{4}}{{Q}_{2} + {Q}_{3} + {Q}_{4}} + \frac{1}{2} {cT}_{0} \frac{{Q}_{4}}{{Q}_{3} + {Q}_{4}} \qquad ( 3 )$$
L: distance to subject
c: speed of light
T₀: emission time of optical pulse
n: number of charge accumulation units provided in pixel (n≥4)
Q₂: pixel signal corresponding to electric charge amount accumulated in second charge accumulation unit
Q₃: pixel signal corresponding to electric charge amount accumulated in third charge accumulation unit
Q₄: pixel signal corresponding to electric charge amount accumulated in fourth charge accumulation unit.

5. A distance image capturing method performed by a distance image capturing device including a light source unit configured to emit an optical pulse to a subject, a light receiving unit including a distance image sensor in which a plurality of pixels, each having a photoelectric conversion element that generates electric charges according to incident light and three or more charge accumulation units that accumulate electric charges, are arranged in a two-dimensional matrix form, and a pixel driving circuit which distributes electric charges to each of the charge accumulation units at an accumulation timing synchronized with an emission timing for emitting the optical pulse and accumulates the electric charges in each of the charge accumulation units, and a distance calculation unit configured to calculate a distance to the subject based on an electric charge amount accumulated in each of the charge accumulation units, the distance image capturing method comprising:
setting a relationship between the emission timing and the accumulation timing such that electric charges corresponding to reflected light of the optical pulse reflected from the subject are accumulated in any two charge accumulation units, in which electric charges are successively accumulated, among the three or more charge accumulation units provided in the pixels; and
calculating, via the distance calculation unit, the distance to the subject by using the same calculation equation regardless of which of the three or more charge accumulation units provided in the pixels accumulates the electric charges corresponding to the reflected light.
